(19) United States
(12) Patent Application Publication
(10) Pub. No.: US 2024/0066918 A1
(43) Pub. Date: Feb. 29, 2024

(54) WHEEL BEARING UNIT FOR A MOTOR VEHICLE AND MOTOR VEHICLE

(71) Applicant: AUDI AG, Ingolstadt (DE)

(72) Inventors: Johannes ALBL, Ingolstadt (DE); Michael FRISCH, Schönberg (DE)

(21) Appl. No.: 18/362,104

(22) Filed: Jul. 31, 2023

(30) Foreign Application Priority Data
Aug. 25, 2022 (DE) 102022121486.9

(51) Int. Cl. B60B 27/00

(52) U.S. Cl. CPC B60B 27/001; B60B 27/0078

(57) ABSTRACT

A wheel bearing unit for a motor vehicle, comprising a wheel hub, a wheel bearing housing and a rolling bearing by which the wheel hub is mounted rotatably in relation to the wheel bearing housing. The rolling bearing has at least one row of rolling elements which are guided on the wheel hub side in a bearing inner ring which is designed as a separate component in relation to the wheel hub and which is fixedly connected to the wheel hub. The wheel hub has a through opening with an inner toothing, via which through opening the wheel hub can be connected in a non-rotational manner to a drive journal which is provided with an external toothing.

### FIELD

The invention relates to a wheel bearing unit for a motor vehicle, as well as to a motor vehicle.

### BACKGROUND

DE 10 2004 054 907 A1, which represents the generic prior art, discloses a wheel bearing unit according to which a wheel hub having an inner toothing is rotatably mounted with respect to a wheel bearing housing via a rolling bearing. A row of rolling elements of the rolling bearing is guided in a bearing inner ring, which is designed as a separate component from the wheel hub and is firmly connected to it. A known problem is that in the region of the bearing inner ring, high notch stresses occur in the tooth base of the inner toothing, which can lead to toothing cracks in the inner toothing of the wheel hub and thus to premature destruction of the wheel hub and ultimately to failure of the wheel bearing unit.

### SUMMARY

The object of the invention consists in further developing a wheel bearing unit in such a way that the occurrence of toothing cracks is avoided and thus an increased service life of the wheel bearing unit is ensured.

In a known manner, the wheel bearing unit comprises a wheel bearing housing, a rolling bearing and a wheel hub which has a through opening with an inner toothing, via which the wheel hub can be connected in a non-rotational manner to a drive journal, having external toothing, of a cardan shaft. The rolling bearing by means of which the wheel hub is rotatably mounted in relation to the wheel bearing housing comprises in a known manner at least one row of rolling elements which are guided on the wheel hub side in a bearing inner ring which is designed as a separate component in relation to the wheel hub and is firmly connected to the wheel hub.

According to the invention, the inner toothing now has a toothless portion which subdivides the inner toothing into a first toothing region and a second toothing region spaced apart therefrom in the axial direction a and which is positioned in such a way that the toothless portion lies radially opposite the bearing inner ring end face on the bearing inner side.

The toothless portion provided in accordance with the invention and its positioning radially opposite the end face on the bearing inner side of the rolling bearing has the effect of minimizing local notch stresses in the tooth root of the inner toothing. This means that it is now advantageously ensured that—since the notch stresses leading to tooth cracks are reduced—an increased service life of the wheel hub and thus of the wheel bearing unit is ensured.

To ensure simple, cost-effective manufacture, the toothless portion is preferably in the form of a turned-out region or undercut—introduced in the through opening of the wheel hub before gear broaching.

As initial tests have shown, the diameter D_{Ab} of the toothless portion should preferably be selected so that the following applies:

$$1 \leq \frac{{D}_{Ab}}{{D}_{F}} \leq 1.2$$

wherein D_{F} denotes the root diameter of the inner toothing or of the toothing portions of the inner toothing.

A further preferred embodiment is characterized in that the through opening of the wheel hub, in addition to the support region formed by the inner toothing, i.e. the first and first toothing portions as well as the toothless portion arranged between the two toothing portions, also comprises a fastening region having an abutment shoulder and an intermediate region which—viewed in the axial direction a—is arranged between the support region and the fastening region, and in that, relative to the root diameter D_{F}, the intermediate region has an intermediate region diameter D_{Z} for which applies:

$$\frac{{D}_{Z}}{{D}_{F}} > 1$$

In addition to the weight saving achieved by the increased diameter, this also ensures in particular that during gear broaching the corresponding broaching tool only engages in the region of the support region, so that the load on the broaching tool is also significantly reduced. Preferably, the intermediate region diameter D_{Z} is larger than the diameter D_{Ab} of the toothless portion of the inner toothing or equal to the diameter D_{Ab}.

Preferably, the fastening region has a fastening region diameter D B for which, with respect to the root diameter D_{F}:

$$\frac{{D}_{B}}{{D}_{F}} > 1.2$$

This ensures that a sufficiently large abutment shoulder is provided.

A further preferred embodiment provides that—viewed in the axial direction a—the toothless portion has an axial portion length L_{Ab} for which the following applies

$$0.1 \leq \frac{{L}_{Ab}}{{L}_{In}} \leq 0.3$$

wherein Lₗₙ denotes the axial length of the inner toothing.

Dimensioning according to the above requirement proves to be particularly advantageous, since, on the one hand, a sufficient length of the toothless portion is ensured for the intended reduction of the notch stress and, on the other hand, the upward limitation also ensures that the toothing portions have a sufficient toothing length for torque transmission.

In order to ensure the most compact possible design of the wheel bearing unit according to a further preferred embodiment it is provided that—viewed in the axial direction a—the intermediate region has an intermediate region length L_{Z} for which, relative to the length Lₗₙ of the inner toothing, the following applies:

$$0.5 \leq \frac{{L}_{Z}}{{L}_{In}} \leq 0.7$$

A further, advantageous embodiment of the wheel bearing unit is characterized in that—viewed in the axial direction a—the fastening region has a fastening region length L_{B} for which, relative to the length Lₗₙ of the inner toothing, the following applies:

$$0.3 \leq \frac{{L}_{B}}{{L}_{In}} \leq 0.6$$

In addition to a compact design, when considered in the axial direction a, this in particular also ensures that sufficient installation space is available for fastening means.

Another object of the invention is to further develop a motor vehicle comprising a wheel bearing unit in such a way that low-wear operation is ensured.

This object of the invention is achieved in that the wheel bearing unit is designed according to any one of claims 1 to 9.

All the explanations concerning the wheel bearing unit according to the invention can be applied analogously to the motor vehicle according to the invention, so that the advantages mentioned above are also achieved with the latter.

### BRIEF DESCRIPTION OF THE FIGURES

Further advantages and possible applications of the invention result from the following description in conjunction with the exemplary embodiment shown in the drawing.

In the drawing:

FIG. 1 shows a side view of a wheel bearing unit of a motor vehicle according to the prior art;

FIG. 2 shows a side view of a wheel bearing unit according to the invention; and

FIG. 3 shows an enlarged portion of FIG. 2.

### DETAILED DESCRIPTION

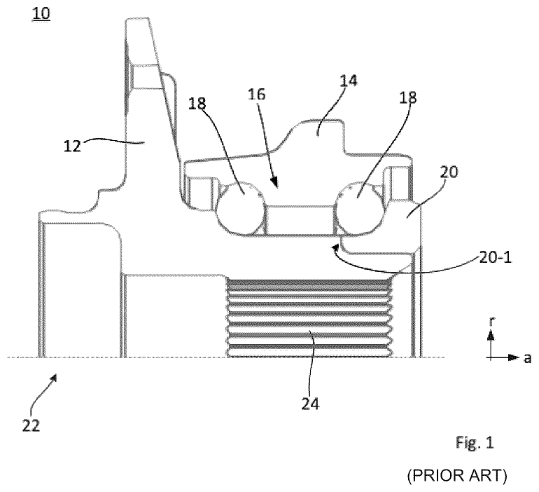

FIG. 1 shows a wheel bearing unit for a motor vehicle, indicated in its totality by the reference numeral 10. The wheel bearing unit 10 comprises a wheel hub 12, a wheel bearing housing 14 and a rolling bearing 16, via which the wheel hub 12 is rotatably mounted relative to the wheel bearing housing 14.

As can be further seen from FIG. 1, the rolling bearing 16 has two rows of rolling elements 18. While the left row of rolling elements 18—in FIG. 1—rolls in a bearing race formed in the wheel hub 12, the right row of rolling elements 18 is guided in a bearing inner ring 20 having a corresponding bearing race and which is firmly connected to the wheel hub 12.

The wheel hub 12 also has a through opening 22, which is provided in some regions with an inner toothing 24. Via the inner toothing 24, the wheel hub 12 can be non-rotatably connected in a known manner to a drive journal of a joint source—not shown here for reasons of clarity—which has external toothing corresponding to the inner toothing 24. In the following, the reference sign D_{Z} denotes the root diameter of the inner toothing 24.

A disadvantage of the prior art is that as a result of the local material taper of the wheel hub 12 caused by the bearing inner ring 20, in particular in the region of the transition to the end face 20-1 of the bearing inner ring 20 on the bearing inner side, high notch stresses occur in the tooth base of the inner toothing 24, which in turn can lead to toothing cracks in the inner toothing 24 and thus cause premature failure of the wheel hub 12 or the wheel bearing unit 10. This is where the invention comes in:

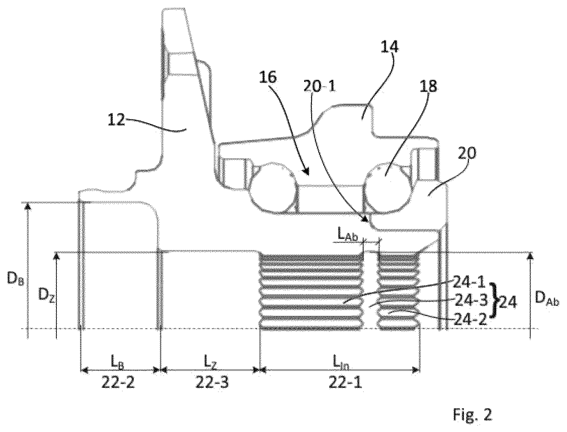

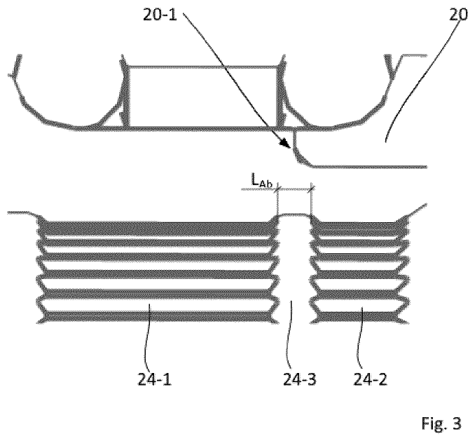

As FIG. 2 and FIG. 3 show, it is now provided that the inner toothing 24 has a first toothing portion 24-1, a second toothing portion 24-2 and a toothless portion 24-3, which, viewed in the axial direction a, lies between the two toothing portions 24-1, 24-2 and separates the two toothing portions 24-1, 24-2 from one other.

As can be further seen from FIG. 2 and in particular FIG. 3, the portions 24-1, 24-2, 24-3 forming the inner toothing 24 are arranged and dimensioned in such a way that, viewed in the axial direction a, the toothless portion 24-3 is positioned radially opposite the end face 20-1 of the bearing inner ring 20 on the bearing inner side.

Since the inner toothing 24 is now designed to be toothless in the critical portion of the wheel hub 12, i.e. in the region of the transition to the end face 20-1 of the bearing inner ring 20 on bearing inner side, it is ensured in an advantageous manner that the local notch stresses leading to toothing cracks are reduced, which has a positive effect on the service life of the wheel hub 12 and thus of the wheel bearing unit 10.

The toothless portion 24-3 is formed in the present case in the form of an undercut or turned region introduced into the through opening 22, and has a diameter D_{Ab} which in the present case is 10% larger than the root diameter D F of the inner toothing 24.

Viewed in the axial direction a, the toothless portion 24-3 is dimensioned such that it has an axial length L_{Ab} corresponding to 10% to 30% of the total length Lₗₙ of the inner toothing 24, see FIG. 2 and FIG. 3.

As can be further seen from FIG. 2, the through opening 22 of the wheel hub 12 has, in addition to the region forming the inner toothing 24, hereinafter also referred to as the support region 22-1, a fastening region 22-2, as well as an intermediate region 22-3 arranged between the support region 22-1 and the fastening region 22-2—as viewed in the axial direction a-.

The reference sign L_{B} denotes the axial length of the fastening region 22-2, and the reference sign L_{Z} denotes the axial length of the intermediate region 22-3. Accordingly, the diameter of the fastening region 22-2 is denoted by D B and the diameter of the intermediate region 22-3 by D_{Z}, see FIG. 2.

In order to minimize the wear of the broaching tool during the manufacture of the inner toothing 24, the diameter of the intermediate region D_{Z} is larger than the root diameter D_{F} of the inner toothing 24. In addition to the lower wear, the increase in diameter also advantageously results in a weight saving. In the present case, the diameter D_{Z} is selected so that it corresponds to the diameter D_{Ab} of the toothless portion 24-3, i.e.

D_{Z}=D_{Ab}=1.1*D^{F}

Thus, the regions 24-3 and 24-2 can advantageously be manufactured in one working step. The fastening region 22-2 is dimensioned in such a way that the fastening diameter D_{B} is larger than the root diameter D_{F} by a factor of 1.2. This ensures that a sufficiently large fastening shoulder 26 is available for the fastening means, such as a nut or bolt, via which the wheel hub 12 is connected to the drive journal of a joint source, see FIG. 2.

To ensure a compact design of the wheel bearing unit 10, the axial lengths L_{B} and L_{Z} of regions 22-2 and 22-3 are presently dimensioned such that the axial length L_{B} of the fastening region 22-2 corresponds to about 30% to 60% of the total length Lₗₙ of the inner toothing 24 and the axial length L_{Z} of the intermediate region 22-3 corresponds to about 50% to 70% of the total length Lₗₙ of the inner toothing 24.

1. A wheel bearing unit for a motor vehicle, comprising a wheel hub, a wheel bearing housing and a rolling bearing by means of which the wheel hub is mounted rotatably in relation to the wheel bearing housing, wherein the rolling bearing has at least one row of rolling elements which are guided on the wheel hub side in a bearing inner ring which is designed as a separate component in relation to the wheel hub and which is fixedly connected to the wheel hub, wherein the wheel hub has a through opening with an inner toothing, via which through opening the wheel hub can be connected in a non-rotational manner to a drive journal which is provided with an external toothing,
wherein the inner toothing is formed comprising a first toothing portion, a second toothing portion and a toothless portion which, viewed in the axial direction, lies between the two toothing portions and separates the two toothing portions from one another, wherein the toothless portion of the inner toothing, viewed in the axial direction, is arranged in such a way that the toothless portion is positioned radially opposite the end face of the bearing inner ring on the bearing inner side.

2. A wheel bearing unit according to claim 1, wherein relative to a root diameter of the toothing portions of the inner toothing, the toothless portion of the inner toothing has a diameter for which applies:
$$1 \leq \frac{diameter ( {D}_{Ab} ) of the toothless portion}{root diameter ( {D}_{F} ) .} \leq 1 , 2$$

3. The wheel bearing unit according to claim 1, wherein the through opening of the wheel hub comprises a support region having the inner toothing, a fastening region having a bearing shoulder, and an intermediate region arranged between the support and fastening regions—as viewed in the axial direction—and in that, relative to the root diameter, the intermediate region has an intermediate region diameter for which applies:
$$\frac{intermediate region diameter ( {D}_{Z} )}{root diameter ( {D}_{F} ) .} > 1$$

4. The wheel bearing unit according to claim 2, wherein the intermediate region diameter is greater than or equal to the diameter of the toothless portion of the inner toothing.

5. The wheel bearing unit according to claim 2, wherein relative to the root diameter, the fastening region has a fastening region diameter for which applies:
$$\frac{fastening region diameter ( {D}_{B} )}{root diameter ( {D}_{F} ) .} \geq 1 , 2$$

6. The wheel bearing unit according to claim 1, wherein viewed in the axial direction, the inner toothing has a length, and in that, relative to the length of the inner toothing, the toothless portion has an axial portion length for which applies:
$$0.1 \leq \frac{portion length ( {L}_{Ab} )}{length of inner toothing ( {L}_{In} ) .} \leq 0.3$$

7. The wheel bearing unit according to claim 3, wherein viewed in the axial direction, the inner toothing has a length, and in that relative to the length of the inner toothing, the intermediate region has an axial intermediate region length for which applies:
$$0.5 \leq \frac{intermediate region length ( {L}_{Z} )}{length of inner toothing ( {L}_{In} ) .} \leq 0.7$$

8. The wheel bearing unit according to claim 3, wherein viewed in the axial direction, the inner toothing has a length, and in that, relative to the length of the inner toothing, the fastening region has an axial fastening region length for which applies:
$$0.3 \leq \frac{intermediate region length ( {L}_{B} )}{length of inner toothing ( {L}_{In} ) .} \leq 0.6$$

9. The wheel bearing unit according to claim 2
characterized in that
the toothless portion of the inner toothing is formed like an undercut.

10. A motor vehicle, comprising a wheel bearing unit, the wheel bearing unit is formed according to claim 1.

11. The wheel bearing unit according to claim 2, wherein the through opening of the wheel hub comprises a support region having the inner toothing, a fastening region having a bearing shoulder, and an intermediate region arranged between the support and fastening regions—as viewed in the axial direction—and in that, relative to the root diameter, the intermediate region has an intermediate region diameter for which applies:
$$\frac{intermediate region diameter ( {D}_{Z} )}{root diameter ( {D}_{F} ) .} > 1$$

12. The wheel bearing unit according to claim 3, wherein the intermediate region diameter (D_{Z}) is greater than or equal to the diameter of the toothless portion of the inner toothing.

13. The wheel bearing unit according to claim 3, wherein relative to the root diameter, the fastening region has a fastening region diameter for which applies:
$$\frac{fastening region diameter ( {D}_{B} )}{root diameter ( {D}_{F} ) .} \geq 1 , 2$$
